(19) United States
(12) Patent Application Publication
(10) Pub. No.: US 2023/0311551 A1
(43) Pub. Date: Oct. 5, 2023

(54) PRINT MEDIA ADVANCE CALIBRATION

(71) Applicant: Hewlett-Packard Development Company, L.P., Spring, TX (US)

(72) Inventors: Eric PASCUAL SOLDEVILLA, Sant Cugat del Valles (ES); Jaume MORERA LUQUE, Sant Cugat del Valles (ES); Marta TUA SARDA, Sant Cugat del Valles (ES)

(73) Assignee: Hewlett-Packard Development Company, L.P., Spring, TX (US)

(21) Appl. No.: 18/004,459

(22) PCT Filed: Jul. 7, 2020
(86) PCT No.: PCT/US2020/040984

§ 371 Date: Jan. 6, 2023

(51) Int. Cl. B41J 29/393; B41J 11/46; B65H 7/14

(52) U.S. Cl. CPC B41J 29/393; B41J 11/46; B65H 7/14; B41J 2029/3935; B65H 2557/61

(57) ABSTRACT

A printer comprises a print carriage, a line sensor, a processor and a controller. The print carriage is configured to print a calibration plot onto print media. The line sensor is configured to emit light onto the calibration plot across the width of the calibration plot and measure the intensity of light reflected from the calibration plot. The processor is configured to determine a correction factor according to a position of a peak in the measured intensity corresponding to a position in the printed calibration plot in which a portion of a first printed mark overlaps a portion of a second printed mark. The controller is configured to adjust the distance by which print media is advanced according to the correction factor. A method for automatically calibrating the advance of print media in a printer comprises printing a calibration plot onto print media, scanning the printed media with a line sensor, determining a correction factor based on a signal from the sensor indicating light intensity across a width of the printed calibration plot and adjusting the advance based on the correction factor.

### BACKGROUND

In a conventional printer, a printhead is mounted on a carriage. In a printing pass, the carriage moves over print media in a width direction and the printhead makes marks on the print media. At the end of the pass, a media advance apparatus advances the print media. After multiple passes, an image can be formed on the print media.

There can be variation in the distance by which the media is advanced after each pass. This variation may arise due to manufacturing variability, wear in the media advance apparatus, or due to the use of media of different types or thicknesses. When printing detailed images, variation in print media advance may affect the print quality. When a QR code or barcode is printed, this may impact the reading of the QR code or barcode. Media advance can be calibrated to correct this variation.

### BRIEF DESCRIPTION OF THE DRAWINGS

FIG. 1 is a schematic view of a printer;

FIGS. 2A-2C are illustrations of a calibration plot;

FIG. 3 is an illustration of a printed pattern comprising a plurality of calibration plots;

FIG. 4 is an illustration of a graphical representation of a signal read by a sensor;

FIG. 5 is an illustration of an enlarged portion of the graphical representation of FIG. 4;

FIG. 6 is an illustration of a graphical representation of a portion of another signal;

FIG. 7 is an illustration of a graphical representation of a portion of another signal;

FIG. 8 is an illustration of a graphical representation of a portion of another signal;

FIG. 9 is an illustration of a graphical representation of a portion of another signal;

FIG. 10 is a flow chart of an example method; and

FIG. 11 is a block diagram of an example of a machine readable medium in association with a processor.

### DETAILED DESCRIPTION

A printer 10 comprises a print carriage 12 with a printhead 14, a line sensor 16, a processor 18 and a controller 20. The print carriage 12 is configured to print a calibration plot 22 onto print media P. The print carriage 12 may be configured to move across the width of the print media P, so that the printhead 14 can print marks on the print media. The controller 20 may be configured to control an advance apparatus 24 to advance the print media P after a pass of the print carriage 12 in an advance direction A.

The line sensor 16 may be provided on the print carriage 12 and may be configured to emit light onto the calibration plot 22 and measure the intensity of light reflected from the calibration plot 22 as the carriage 12 moves across the width of the print media. The line sensor 16 may thereby obtain an intensity signal across the width of the print media. The line sensor 16 being provided on the print carriage 12 may allow the intensity measurements to be obtained during printing.

The calibration plot 22 may be an interference plot, wherein a first pattern is printed and a second pattern is printed over the first pattern. The processor 18 is configured to determine a correction factor according to a position of a peak in the intensity measured by the line sensor 16, wherein the position of the peak corresponds to a position in the printed calibration plot 22 in which a portion of a first printed mark overlaps a portion of a second printed mark. The controller 20 is configured to adjust the distance by which print media is advanced according to the correction factor.

Conventional methods of manual calibration can be time-consuming. The line sensor 16 being configured to measure intensity of light of the calibration plot and the processor 18 being configured to determine the correction factor may provide an automatic method of calibration, which may reduce burden on the operator and may be time-saving. Furthermore, the automatic method may improve accuracy in determining the correction factor, and the apparatus may be configured to determine a correction factor to a greater resolution than when determining the determining the correction factor manually. The printing of a calibration pattern and the detection using a line sensor may allow the printer to be calibrated for a wide variety of types of media, for example generic vinyl, cast vinyl, PVC banner, coated paper, wall paper and canvas.

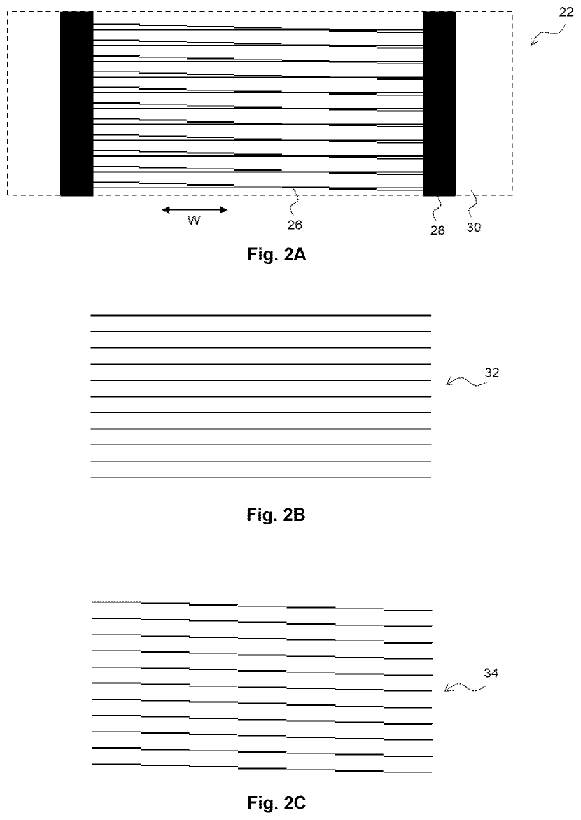

In an example, the interference pattern may be a Vernier pattern 26, as shown in FIG. 2A. The provision of a Vernier pattern in the calibration plot 22 may provide improved accuracy in the calibration method. The calibration plot 22 may comprise a black region 28 adjacent the Vernier pattern 26 and a white, unprinted region 30 adjacent the black region. The black and white regions 26, 28 may be provided at each end of the Vernier pattern 26 in the width direction W.

The Vernier pattern 26 may be printed by printing a regular line pattern 32 onto the print media, as shown in FIG. 2B and printing a stepped line pattern 34, as shown in FIG. 2C, on top of the regular line pattern 32, wherein the regular line pattern 32 comprises a plurality of parallel lines separated by a constant distance and the stepped line pattern 34 comprises a plurality of stepped lines, wherein the length of each step is shorter than the separation distance between the parallel lines of the regular line pattern 32. The separation between the lines in the regular line pattern 32 may be short enough to be read by the line sensor 16, but great enough to allow a plurality of the steps of the stepped line pattern 34 between the regular lines, to cover a desired media advance error range.

The Vernier pattern 26 may comprise a plurality of columns, wherein the width of each column is defined by the width of the steps of the stepped line pattern 34. The processor 18 may be configured to determine a correction value based on the column of Vernier pattern in which the stepped line pattern 34 overlaps the regular line pattern 32.

The stepped pattern 34 may be printed so that in a predetermined column, preferably the central column, the stepped pattern would overlap the regular pattern if there was no error in the advance of the print media. If there is an error in the print advance, the column wherein the stepped line pattern 34 overlaps the regular line pattern 32 will indicate the correction value, because this column will indicate how much more or less the print media is advanced compared to the separation between the regular lines. The number of columns printed may depend on the resolution of the Vernier pattern 26, which determines the length of each step in the advance direction. Because the Vernier pattern 26 is read by a line sensor 16 rather than manually by eye, the resolution of the Vernier pattern 26 may be finer than that of a Vernier pattern printed for manual calibration.

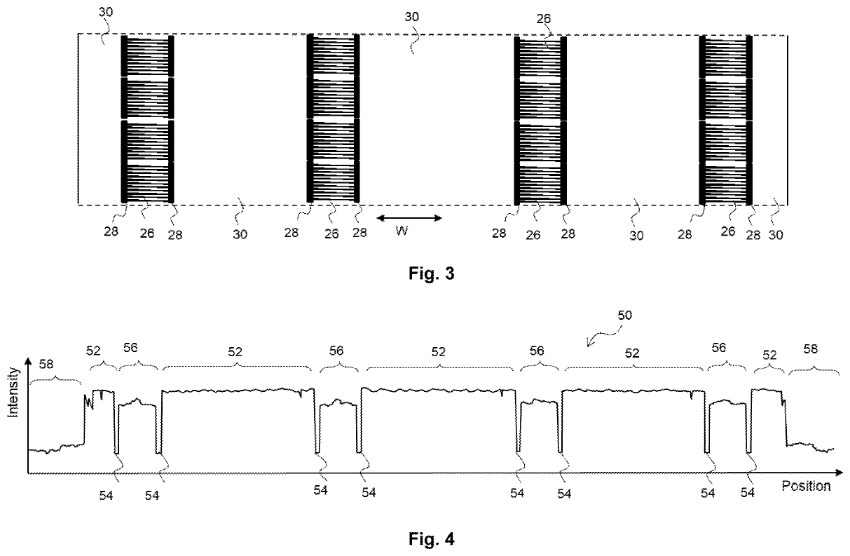

A plurality of the calibration plots 22 may be printed. For example, a plurality of calibration plots 22 may be printed across the width of the print media, as shown in FIG. 3 and a plurality of calibration plots 22 may be printed along the length of the print media. In an example, 100 or 120 calibration plots 22 may be printed. The correction factor may be determined based on an average of correction values determined from the plurality of calibration plots 22.

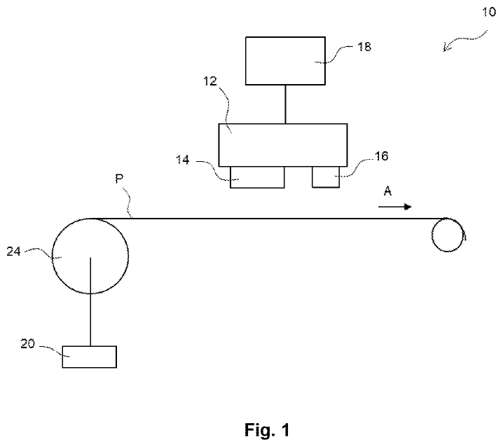

The line sensor 16 is configured to reflect light from the calibration plot and measure the intensity of the reflected light. The line sensor 16 may be provided on the print carriage 12, after the printhead 14, as shown in FIG. 1, so that the line sensor 16 may detect the calibration plot during printing. The line sensor 16 may comprise a plurality of LEDs of different colours. For example, the line sensor may comprise a sequence of red, green, blue and amber LEDs. The processor 18 may be configured to determine whether a first LED of the plurality of LEDs is functional, prior to the line sensor 16 measuring the intensity of light reflected from the calibration plot. If the first LED is not functional, the processor 18 may be configured to determine whether a second LED of the plurality of LEDs is functional. For example, the sensor signal may be saturated if the reflected intensity is too high, due to the intensity of the LED being too high. Similarly, it may not be possible to determine the correction value if the reflected intensity is too low, due to the intensity of the LED being too low.

The processor 18 may be configured to determine that the first LED of the plurality of LEDs is functional if a predetermined proportion of the signal is between a lower level and a higher level. For example, if the LED sensor saturates at a value of 1023, if a test signal has more than 30% of measurement values greater than 1010 or more than 30% of measurement values below 50, then the processor may determine that the LED is not functional.

An example graphical representation of a sensor signal 50 is shown in FIG. 4. The sensor signal 50 indicates the intensity of light across with width of the print media. The sensor signal 50 of FIG. 4 is of a width of print media having four calibration plots. First portions 52 of the signal in which the intensity is high correspond to the white unprinted parts of the calibration plots 22 shown in FIGS. 2A and 3. Second portions 54 of the signal in which the intensity is low correspond to black parts 28 of the calibration plots 22. Third portions 56 of the signal in which the intensity plateaus at a value lower than the intensity at the first portions correspond to the Vernier pattern 26. Fourth portions 58 of the signal at the left and right ends correspond to measurement where there is no print media, beyond the left and right edges of the print media.

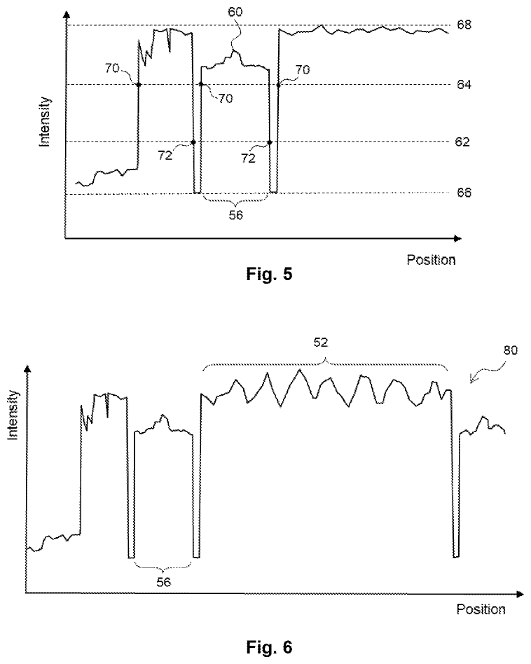

FIG. 5 shows an enlarged portion of the graphical representation of FIG. 4. As shown in FIG. 5, there is a peak 60 in intensity at the third portion 56 of the signal corresponding to the Vernier pattern 26. The position of the peak 60 corresponds to the column in the Vernier pattern 26 in which a stepped line overlaps a line of the regular line pattern. The correction value can be determined based on the position of this peak.

The processor 18 may be configured to determine the position of the peak based on the sensor signal.

The processor 18 may be configured to filter noise from the signal. The processor 18 may be configured to determine a black threshold value 62 in intensity and a white threshold value 64 of intensity, based on a minimum value 66 of intensity, which may correspond to the black region 28 or a region where no media is present, as shown in FIG. 5, and a maximum value 68 of the intensity corresponding to the white region 30. The processor 18 may be configured to filter noise from the signal 50 based on the black threshold value and white threshold value. The use of two thresholds may make the filtered signal more robust to noise. With these two thresholds, the noise would need to be very strong and make a high brightness change to pass the thresholds.

The value of the black threshold 62 may be equal to the following relationship: (maximum value-minimumvalue)×α+minimum value. The value of the white threshold 64 may be equal to the following expression: (maximum value−minimum value×β+minimum value. The values of α and β may be determined experimentally. For example, α may be 0.23 and β may be 0.40.

The processor 18 may be configured to determine key points in the signal, as shown in FIG. 5. The processor 18 may be configured to determine as key points in the signal, points 70 at which the signal comes from below the black threshold and crosses the white threshold and points 72 at which the signal comes from above the white threshold and crosses the black threshold. The points 70 which the signal comes from below the black threshold and crosses the white threshold may be determined to be up points, and the points 72 at which the signal comes from above the which threshold and crosses the black threshold may be determined to be down points.

The processor 18 may be configured to detect the position of the portion of the signal corresponding to the Vernier pattern based on the up points 70 and down points 72. The processor 18 may be configured to determine vectors between neighbouring key points. The processor may be configured to detect the position of the Vernier pattern portion of the signal based on the determined vectors. For example, the processor 18 may be configured to determine the position of the black regions based on a value of a vector between a down point 72 and an up point 70 and the processor may be configured to determine the position of the Vernier pattern as being between two black regions 54. The processor may be configured to determine the position of the Vernier pattern based on a value of a vector of between an up point 70 and a down point 72 between the two black regions 54.

When the position of the Vernier pattern portion of the signal has been detected, the processor 18 may be configured to determine the position of the peak 60 in the Vernier pattern. The processor 18 may be configured to calculate a running average across the Vernier pattern with an interval corresponding to the width of a column. The processor 18 may be configured to discard from the running average calculation values greater than a predetermined value, for example greater than 90% of the maximum value. This may make the process more robust to isolated peaks.

The processor 18 may be configured to advance the running average ten points, to reduce CPU calculations. Experiments have indicated that this does not compromise the accuracy nor robustness of the determining the position of the peak. The processor 18 may be configured to find the maximum value inside the running average and convert it to the calibration value. For example, the processor may use the relationship:

calibration value=[−4+8×(position of Vernier point−left boundary position)/(right boundary position-left boundary position)]×δ

to determine the calibration value.

The processor 18 may be configured to discard signals corresponding to non-confident detected Vernier patterns. The processor 18 may be configured to determine a non-confident detected Vernier pattern according to the line sensor signal.

The processor 18 may be configured to determine a variance at an unprinted white region 52 adjacent the Vernier pattern portion 56. The processor 18 may be configured to determine whether the variance is greater than a predetermined value. The processor 18 may be configured to determine the detected Vernier pattern as a non-confident Vernier pattern if it is determined that the variance is greater than the predetermined value.

For example, as shown in FIG. 6, a signal 80 from the line sensor may include excessive variance in the non-printed white portion 52 of the signal due to wrinkles in the print media. The processor 18 may be configured to normalize the variance, to avoid discarding Vernier patterns that have a higher variance due to brightness rather than noise caused. The processor may determine the variance rather than the variability, to discard signals with larger deviations, rather than signals with smaller high frequency noise.

The processor 18 may be configured to determine a variance in the line sensor signal at the Vernier pattern 56. The processor 18 may be configured to determine whether the variance is greater than a second predetermined value. The processor 18 may be configured to determine the detected Vernier pattern as a non-confident Vernier pattern if it is determined that the variance is greater than the second predetermined value.

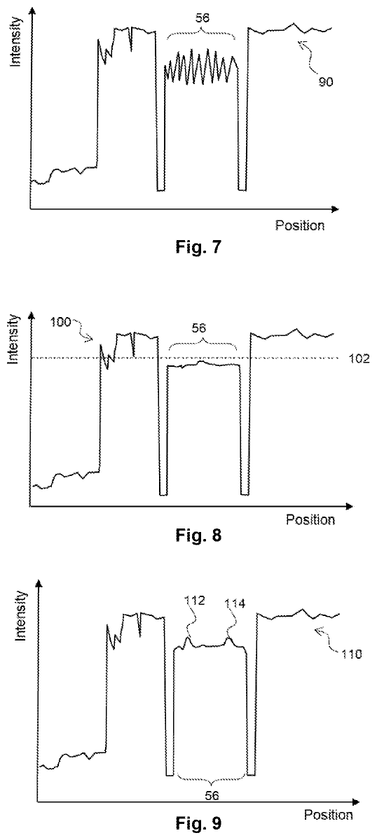

For example, as shown in FIG. 7, a signal 90 may include excessive variance in the Vernier pattern portion 56, due to other printing present over the Vernier pattern, for example numbers labelling the columns of the Vernier pattern. To determine whether the signal is a non-confident signal, the processor 18 may be configured to normalise the variance, to avoid discarding Vernier patterns that have a higher variance due to brightness rather than noise 30 caused. The processor 18 may determine the variance rather than the variability, to discard signals with larger deviations, rather than signals with smaller high frequency noise.

The processor 18 may be configured to determine a value of intensity of the peak in the Vernier pattern portion of the line sensor signal. The processor may be configured to determine whether the peak in intensity is less than a predetermined threshold, and may be configured to determine the detected Vernier pattern as a non-confident Vernier pattern if the peak in intensity is below the predetermined threshold.

For example, as shown in FIG. 8, a printed Vernier pattern portion 56 of a line sensor signal 100 may not have a strong peak and may be affected by noise, inducing high errors on the measurements. The processor may be configured to determine an average value of intensity of the Vernier pattern and may be configured to determine the threshold 102 based on the average, for example a multiple of the average, such as 103% of the average.

The processor 18 may be configured to determine a detected Vernier pattern to be a non-confident pattern based on the presence of a second peak in the Vernier pattern portion 56 of the line sensor signal. For example, the processor 18 may be configured to determine whether the signal of the Vernier pattern comprises a maximum peak in intensity and a second peak with an intensity greater than a proportion of the intensity of the maximum peak and the separation of the maximum beak and second peak is greater than a predetermined distance.

For example, as shown in FIG. 9, a Vernier pattern portion 56 of a line sensor signal 110 may comprise more than one strong peak separated by a large distance, which may be caused by wrinkles in the print media or an error in the printing of the Vernier pattern. The processor 18 may be configured to determine compare the intensity of the first peak 112 and the second peak 114, and may be configured to determine the distance between the first peak 112 and the second peak 114. For example, if the intensity of the second peak 114 is determined to be greater than 98% of the intensity of the first peak 112 and the second peak 114 is separated by a distance corresponding to more than two columns of the Vernier pattern, the processor 18 may be configured to determine that the signal 110 of the Vernier pattern is a non-confident signal.

After the non-confident Vernier patterns have been discarded, the processor 18 may be configured to determine the correction factor as an average of the plurality of the correction values from the accepted Vernier patterns. The processor 18 may be configured to determine whether the number of accepted Vernier patterns is greater than a minimum acceptance. For example, a minimum acceptance may be sixty Vernier patterns. This may reduce the error on the determined correction factor.

The processor 18 may be configured to determine the dispersion of each individual correction value against the average, the correction factor. The processor may be configured to determine a dispersion range which incorporates a majority of the individual correction values. In an example, it may be determined that an interval of ±0.75 incorporates the majority of the individual correction values. The processor 18 may analyse the non-confident Vernier patterns that were discarded due to there being a second peak in the Vernier pattern portion of the signal and may accept the discarded Vernier patterns in which the first peak or the second peak is within the dispersion range of the average and may determine the correction value of the peak that is within the dispersion range. This may increase the number of accepted Vernier patterns, without adding significant error to the determined correction factor.

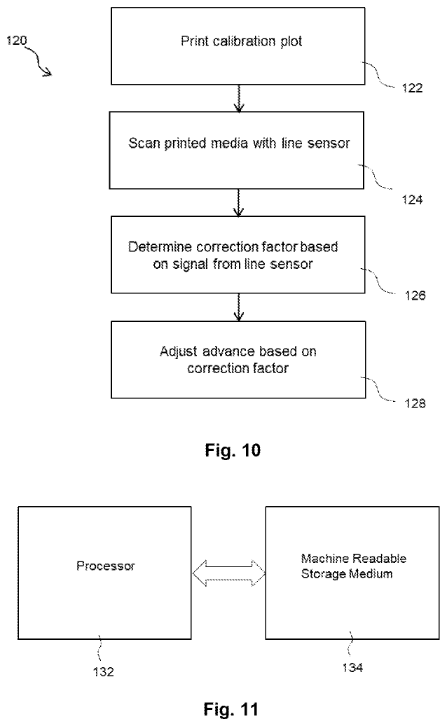

FIG. 10 shows a flowchart of an example method 120. The method may be executable by the printer 10 shown in FIG. 1.

The method comprises, in block 122, printing a calibration plot onto print media. Printing the calibration plot may comprise printing a Vernier pattern 26 by printing a regular line pattern onto the print media and printing a step line pattern on top of the regular line pattern, wherein the regular line pattern comprises a plurality of parallel lines separated by a constant distance and the step line pattern comprises a plurality of stepped lines wherein the length of each step is shorter than the separation distance between the parallel lines of the regular line pattern.

The method comprises, in block 124, scanning the printed media with a line sensor. Scanning the printed media with a line sensor may comprise reflecting light on the printed media and measuring the intensity of the reflected light. The method may comprise determining whether a first LED of a plurality of LEDs of the line sensor is functional, prior to the scanning the printed media.

The method comprises, in block 126, determining a correction factor based on a signal from the sensor indicating light intensity across a width of the printed calibration plot. Determining the correction factor may comprise determining a location along the width of the printed media in which a portion of the stepped lines overlap the regular lines. Determining the location may comprise determining a position of a peak in intensity in the line sensor signal.

The method may comprise filtering noise form the line sensor signal, by determining a black threshold value in intensity and a white threshold value in intensity.

Determining the position of the peak in intensity may comprise determining key points in the signal, wherein the key point comprise up points at which the signal comes from below the black threshold and crosses the white threshold and down points at which the signal comes from above the white threshold and crosses the black threshold. Determining the position of the peak in intensity may comprise determining vectors between neighbouring key points and detecting the position of the Vernier pattern based on the determined vectors.

The method may comprise determining a non-confident detected Vernier pattern according to the line sensor signal and discarding the non-confident detected Vernier pattern.

The method comprises, in block 128, adjusting the advance based on the correction factor.

The method may comprise printing a plurality of the calibration plots, and determining the correction factor may comprise determining an average of correction values based on signals from the line sensor for each of the calibration plots.

The method may comprise performing the printing the calibration plot, the scanning the printed media, the determining the correction factor and the automatically adjusting the advance each time a different media is used for printing.

Various elements and methods described herein may be implemented through the execution of machine-readable instructions by a processor. FIG. 11 shows a processing system comprising a processor 132 in association with a non-transitory machine-readable storage medium 134. The machine-readable storage medium may be a tangible storage medium, such as a removable storage unit or a hard disk installed in a hard disk drive. The machine-readable storage medium comprises instructions to print a calibration plot onto print media, the calibration plot comprising a plurality of interference patterns, wherein each interference pattern is separated by a white, unprinted region and at least one black region. The interference pattern may be the Vernier pattern 26 shown in FIG. 2A.

The machine-readable storage medium comprises instructions to scan the printed media with a line sensor and instructions to determine a correction factor based on the signals from the sensor, wherein the signals from the sensor indicate light intensity across a width of the plurality of printed interference patterns. The machine-readable storage medium comprises instructions to control a printer to adjust the advance of print media based on the correction factor.

The machine-readable storage medium may comprise instructions to determine the correction factor determining a position of a peak in intensity in the line sensor signal. The machine-readable storage medium may comprise instructions to filter noise from the line sensor signal by determining a black threshold value in intensity and a white threshold value in intensity.

The machine-readable storage medium may comprise instructions to determine key points in the signal, wherein the key point comprise up points at which the signal comes from below the black threshold and crosses the white threshold and down points at which the signal comes from above the white threshold and crosses the black threshold. The machine-readable storage medium may comprise instructions to determine the position of the peak in intensity by determining vectors between neighbouring key points and detecting the position of the Vernier pattern based on the determined vectors.

The machine-readable storage medium may comprise instructions to discard a signal of a Vernier pattern if the Vernier pattern is determined to be a non-confident Vernier pattern.

According to examples described herein, advance calibration may be performed automatically, which may improve accuracy. Improved accuracy in advance calibration may improve print quality. Scanning the printed calibration plot using a line sensor provided on the print carriage may allow the intensity measurements to be obtained during printing. The printing of a Vernier pattern for determining the correction factor may improve accuracy of the advance calibration.

1. A method for automatically calibrating the advance of print media in a printer comprising:
printing a calibration plot onto print media;
scanning the printed media with a line sensor;
determining a correction factor based on a signal from the sensor indicating light intensity across a width of the printed calibration plot;
adjusting the advance based on the correction factor.

2. The method according to claim 1, wherein printing the calibration plot comprises printing a Vernier pattern by printing a regular line pattern onto the print media and printing a step line pattern on top of the regular line pattern, wherein the regular line pattern comprises a plurality of parallel lines separated by a constant distance and the step line pattern comprises a plurality of stepped lines wherein the length of each step is shorter than the separation distance between the parallel lines of the regular line pattern.

3. The method according to claim 2, wherein determining the correction factor based on the line sensor signal comprises determining a location along the width of the printed media in which a portion of the stepped lines overlap the regular lines, wherein the determining the location comprises determining a position of a peak in brightness from the line sensor signal.

4. The method according to claim 1, comprising printing a plurality of the calibration plots, and wherein determining the correction factor based on the signal from the line sensor comprises determining an average of a correction value based on a signal from the line sensor for each of the calibration plots.

5. The method according to claim 1, comprising performing the printing the calibration plot, the scanning the printed media, the determining the correction factor and the automatically adjusting the advance each time a different media is used for printing.

6. A printer comprising:
a print carriage configured to print a calibration plot onto print media,
a line sensor configured to emit light onto the calibration plot across the width of the calibration plot, and measure the intensity of light reflected from the calibration plot;
a processor configured to determine a correction factor according to a position of a peak in the measured intensity corresponding to a position in the printed calibration plot in which a portion of a first printed mark overlaps a portion of a second printed mark.
a controller configured to adjust the distance by which print media is advanced according to the correction factor.

7. The printer according to claim 6, wherein the line sensor comprises a plurality of LED light sources, and wherein the processor is configured to determine whether an LED of the plurality of LEDs is functional, before the line sensor measures the intensity of light reflected from the calibration plot, wherein if the LED is not functional, it is determined whether a second LED of the plurality of LEDs is functional.

8. The printer according to claim 6, wherein the calibration plot comprises a Vernier pattern, a black region adjacent the Vernier pattern in the width direction, and a white unprinted region adjacent the black region in the width direction, wherein the processor is configured to determine a black threshold value in intensity and a white threshold value in intensity based on a maximum value of the intensity corresponding to the white region and a minimum value of the intensity corresponding to the black region.

9. The printer according to claim 8, wherein the processor is configured to filter noise from the line sensor signal according to the black threshold value and the white threshold value.

10. The printer according to claim 8, wherein the processor is configured to determine the location of the Vernier pattern in the signal by determining key points in which the signal crosses the black threshold and key points in which the signal crosses the white threshold, determining vectors between the key points, and determining the location of the Vernier pattern based on the determined vectors.

11. A non-transitory machine-readable storage medium encoded with instructions executable by a processor, the machine-readable storage medium comprising:
instructions to print a calibration plot onto print media, the calibration plot comprising a plurality of interference patterns, wherein each interference pattern is separated by a white, unprinted region and at least one black region;
instructions to scan the printed media with a line sensor;
instructions to determine a correction factor based on signals from the sensor, wherein the signals from the sensor indicate light intensity across a width of the plurality of printed interference patterns;
instructions to control a printer to adjust the advance of print media based on the correction factor.

12. A non-transitory machine-readable storage medium according to claim 11, wherein the interference pattern is a Vernier pattern, and the non-transitory machine-readable storage medium comprises instructions to discard a signal of a Vernier pattern of the plurality of Vernier patterns, if the variance in the signal at an unprinted region adjacent the Vernier pattern is greater than a first predetermined value.

13. The non-transitory machine-readable storage medium according to claim 11, wherein the interference pattern is a Vernier pattern, and the non-transitory machine-readable storage medium comprises instructions to discard a signal of a Vernier pattern, if the variance in the signal across the Vernier pattern is greater than a second predetermined value.

14. The non-transitory machine-readable storage medium according to claim 11, wherein the interference pattern is a Vernier pattern, and the non-transitory machine-readable storage medium comprises instructions to discard a signal of a Vernier pattern of the plurality of Vernier patterns if the value at a peak in the intensity of the signal at the Vernier pattern is less than a predetermined multiple of the average value intensity of the signal across the Vernier pattern.

15. The non-transitory machine-readable storage medium according to claim 11, wherein the interference pattern is a Vernier pattern, and the non-transitory machine-readable storage medium comprises instructions to discard a signal of a Vernier pattern of the plurality of Vernier patterns if the signal of the Vernier pattern comprises a maximum peak in intensity and a second peak with an intensity greater than a proportion of the intensity of the maximum peak and the separation of the maximum peak and the second peak is greater than a predetermined distance.
